(19) United States
(12) Patent Application Publication
(10) Pub. No.: US 2017/0243235 A1
(43) Pub. Date: Aug. 24, 2017

(54) SYSTEM TO MONITOR AND ANALYZE SHOPPER BEHAVIOR AND METHOD OF USE THEREOF

(71) Applicant: eyeQ Inc., Austin, TX (US)

(72) Inventors: Michael Garel, Austin, TX (US); Jim Wang, Austin, TX (US); Peter William Rackl, Austin, TX (US)

(73) Assignee: eyeQ Inc., Austin, TX (US)

(21) Appl. No.: 15/438,260

(22) Filed: Feb. 21, 2017

Related U.S. Application Data
(63) Continuation-in-part of application No. PCT/US2017/018435, filed on Feb. 17, 2017.
(60) Provisional application No. 62/418,527, filed on Nov. 7, 2016.
(60) Provisional application No. 62/297,282, filed on Feb. 19, 2016.

(51) Int. Cl. G06Q 30/02; G06K 19/06; G06T 7/70; H04N 7/18; H04N 5/225

(52) U.S. Cl. CPC G06Q 30/0201; H04N 7/185; H04N 5/2252; G06T 7/70; G06K 19/06028; G06K 19/06037; H04W 84/12

(57) ABSTRACT

A device/system and method of use thereof, that is capable of observing customer interactions with a display without the need to be connected to an outlet power source and can be self-contained. The device is capable on being run by a battery pack for an extended period of time and can be readily attached and un-attached from the display with simple effort. The device can have a camera to record visual data of the customers (for later analysis), a presence sensor (to detect customer movement), a WIFI module (to receive information from customers' mobile devices), and a CPU and memory card to store the information gathered. The device can be in a compact package design that allows it to be seamlessly attached and unattached as a unit, and can be used as the package for sending to an outside site for analysis the monitored behavior of the customers. The device can be part of a larger system that utilizes the observational devices as scout devices in combination with a monitoring and analyzing system directly connected to a wall-power source.

### RELATED PATENT APPLICATIONS

This application claims priority to U.S. Patent Application Ser. No. 62/297,282, filed Feb. 19, 2016, entitled “Device To Monitor And Analyze Shopper Behavior,” and to U.S. Patent Application Ser. No. 62/418,527, filed Nov. 7, 2016, entitled “Display Observation System And Method Of Use Thereof” This application also claim priority to PCT Patent Application No. PCT/US17/18435, filed Feb. 17, 2017, entitled “System To Monitor And Analyze Shopper Behavior And Method Of Use Thereof”

This application is also related to PCT International Patent Application No. PCT/US14/47294 and U.S. Patent Application Publ. No. 2015/0025936, to Garel et al., both filed Jul. 18, 2014, entitled “System For Monitoring And Analyzing Behavior And Uses Thereof ” Each of these applications claims the benefit of provisional United States Patent Application Serial No. 61/856,525, filed on July 19, 2013, entitled “System For Monitoring And Analyzing Consumer Purchasing Behavior In Real-Time To Drive Sales Via Engaging Digital Customer Experiences.”

Each of these patent applications is commonly assigned to the Assignee of the present invention, and each is hereby incorporated herein by reference in its entirety for all purposes.

### FIELD OF INVENTION

A system and method of use for monitoring and analyzing behavior in various applications. The system and method of use can observe customer reactions and shopping patterns in response to a store display, or other display, and monitoring and analyzing customer behavior.

### BACKGROUND OF INVENTION

eCommerce systems today capture and analyze vast amounts of shopper data that enable web and mobile commerce retailers and brands to make better decisions on things including promotions, marketing, pricing, product design, and mix. Generally, bricks and mortar retailers and their brands are blind to in-store shopper behavior.

The retail industry is a highly competitive industry, particularly in this age of on-line and brick-and-mortar retail stores competing for customers. Typically, a brick-and-mortar retail store will set up displays to promote certain products tailored to its customers, and often to particular demographics within its customers. Determining how well the display succeeds in such promotional activities is generally difficult to determine and a challenge faced by such retail stores. Delivering the right message to the right time to a customer that influences purchasing is one of a retail store's biggest impediments.

Currently, the greatest fear in brick-and-mortar retail is showrooming. Showrooming is defined as when a shopper visits a brick-and-mortar store to check out a product, but then either heads home or uses a mobile device in-store to make the purchase from an online retail establishment. It is estimated that over 47% of consumers showroom today, with that number increasing exponentially each year. Many retailers are closing stores due to this phenomenon. Though brick-and-mortar retail still accounts for approximately 90% of all retail purchases, online retail as a percentage of total retail is growing at over 10% annually. This places incredible stress on physical retail as they need to bring in more sales at a larger margin than online retailers to compensate for their large overheads.

In order to combat this continued online retail growth, brick-and-mortar retailers and brands need to provide the right message to the right customer at the right time, an issue they continue to struggle with. Today's shopper expects the information they are provided in-store to be relevant to their needs. Online retail has the ability to use data driven practices to provide optimized messaging to their customers that will influence their purchasing. Brick-and-mortar retailers do not have this ability today.

Today's toolbox for brick-and-mortar retailers and brands to understand consumer purchasing behavior is Point-of-Sale (POS) data. POS data is used to determine not only the stores revenue, but also overall consumer traffic, advertising effectiveness, inventory forecasting, and proper product mix. A challenge the retail industry currently faces is the lack of consumer purchasing data prior to the sale. Generally, the methods used to determine consumer behavior prior to POS are focus groups, traffic counting devices, surveys, feedback from employees, and shopper shadows. None of these methods provides the retailer with a fraction of the information that could be used to determine effectiveness of store layout, inventory management, merchandising, at-shelf promotion, sales team positioning, and product feedback to the manufacturer/merchandizer.

Retailers and brands invest a significant amount of dollars in their Point of Purchase (POP) displays. There is an estimated 150 million POP displays shipped to retailers annually in the United States alone. Measuring and analyzing the performance of those displays can be critical to a brands ability to succeed in today's market, where brand loyalty is at an all time low. Over 70% of brand decisions are made at the shelf, and brands need to ensure their messages are correct on POP displays to remain competitive in the market. Today, brands have zero insight into the performance of their POP displays and the shopper behavior around their displays.

Additionally, retailers are faced with the challenge of having the right inventory on the shelf at the precise time the consumer wants to make their purchase. Today's forecasting methods rely on historical and POS data. With the only data available to the retailer being after-the-fact, they lack a portion of important data required to improve the effectiveness of their forecasting and inventory models. Finally, retailers are interested in methods to influence and accelerate the consumer buying cycle. While online retailers continue to improve personalized shopping experiences by presenting offerings based on previous purchases or pre-set preferences, traditional advertising and merchandising methods do not effectively personalize marketing and promotional material toward a specific consumer to directly influence their purchasing decision.

There are systems, including those created by the Applicant, to help provide insights to brands and retailers. For instance, commonly owned U.S. Patent Application Publ. No. 2015/0025936, entitled “System for Monitoring and Analyzing Behavior And Uses Thereof,” to Garel et al. (“Garel '936 Application”) discloses systems for monitoring and analyzing behavior in various applications and uses thereof. Generally, the systems (and uses thereof) are for monitoring and analyzing consumer purchasing behavior in real-time to drive sales via engaging digital customer experiences. In embodiments, the disclosed system can include a retail store system that features and includes MAC address tracking, user eye tracking, object identification of goods on shelves, open API, advertising broker rules engine. In addition, the system can include a customer engagement with interactive output displays including displays with demographic intelligence, displays with demographics and MAC-panels throughout store at product, displays with demographics and MAC-single panel or few panels scattered throughout store, automated customer assistance at shelf, customer purchase at shelf

Other systems include those based on specific smartphone applications that may or may not further rely on in-store devices like the iBeacon (AdMobilize, Miami, Fla.) (see http://venturebeat.com/2015/07/02/admobilize-unveils-its-newest-real-world-analytics-so-advert isers-can-pay-per-face/).

Such systems require various equipment to be installed that needs to be electrically connected to an outlet power sources (i.e., such systems require either power at the shelf or a specific smartphone application (app)).

The problem with requiring power is that the optimal placement for such a device may not be within range of the wall-power source. Thus, retail stores often set up displays in areas that it is difficult or onerous to connect power sources. Indeed, the displays often stand in areas of the retail store that such connection would be not be practical and could potentially diminish the aesthetics of the display that is being utilized.

Often, the entity desiring to place the device is not the retail store, but rather the brand. As the brand is not in control of the wall-power source and the retailer is unwilling (for whatever reasons) to provide a wall-power source locally, the need exists to have a simple device that does not require a wall-power source. The problem with requiring a specific smartphone app is that the adoption rates for such apps tend to be very low (generally single digit percentages) in any given shopper population. Therefore, the need exists to for a device that is not app-dependent or wall-power dependent to gather shopper behavior data for the retailer, the brand, or both.

Presently, however, there is no method for a brand, retailer, or other physical presence (i.e., stadium, airport, mall, tradeshow booth, etc.) to use a simple device that does not require external power to measure and analyze shopper behavior without a mobile application. These devices could be used in locations such as on retail shelves, end caps, stand-alone displays, corrugated cardboard displays, and walls—essentially any surface can be used to mount these devices.

Accordingly, there is a need to provide a system and method of use in which information about the customers interacting with such displays are observed (monitored and recorded) that does not require it to be electrically connected to an outlet power source and that is not intrusive to the display.

The need also exists for this information to be readily sent to an outside system for analysis that is both user friendly to the retail store and economical.

### SUMMARY OF INVENTION

The present invention is a system and method of use for monitoring and analyzing behavior in various applications. The system and method of use can observe customer reactions and shopping patterns in response to a store display, or other display, and monitoring and analyzing customer behavior.

In some embodiments, the present invention is directed to an observational device, and method of use thereof, that is self-contained and capable of observing customer interactions with a display without the need to be connected to an outlet power source. The observational device is, instead, capable on being run by a battery pack for an extended period of time, such as 90 days, and can be readily attached and un-attached from the display with simple effort. The observational device/system can have a camera to record visual data of the customers for later analysis (such as encrypted images), a presence sensor (to detect customer movement), a WIFI module (to receive information from customers' mobile devices or to communicate with a WIFI network), and a CPU and memory card to store the information gathered. Optionally, a module for wirelessly communicating, such as a mobile broadband radio module, a cellular module, a Bluetooth device, Zigbee device, etc. The observational device can be in a compact package design that allows it to be seamlessly attached and unattached as a unit, and can be used as the package for sending to an outside site for analysis the monitored behavior of the customers.

In other embodiments, the system (and use thereof) is one that incorporates the observational device/system with a system for monitoring and analyzing consumer purchasing behavior in real-time, in aggregate, and over time, to help the retailer or brand drive sales via engaging digital customer experiences and/or otherwise optimize the shopping experience. While the observational device/system would be utilized in the monitoring and analyzing system without wall power (such as a battery pack), the monitoring and analyzing system would be connected to wall power.

In general, in one embodiment, the invention features a system that includes an observational device. The observational device includes a presence sensor. The presence sensor is operable to sense traffic of persons in proximity of the observational device. The observational device further includes a camera. The camera is operable to intermittently take images of the persons. The observational device further includes a WIFI module. The WIFI module is operable to obtain data from mobile devices carried by the persons. The observational device further includes a processor. The processor is electrically connected to the presence sensor, the camera, and the WIFI module. The processor is operable to save information gathered by the presence sensor, the camera, and the WIFI module. The observational device further includes a non-wall power source. The non-wall power sources power for the presence sensor, the camera, the WIFI module, and the processor. The observational device operable for use for a pre-set period of time without being connected to a wall-power source.

Implementations of the invention can include one or more of the following features:

The pre-set period of time can be at least 60 days.

The system can be the observational device.

The observational device can be a self-contained observational device.

The self-contained observational device can include an enclosure made of a light, durable material.

The light, durable material can be cardboard, plastic, or a combination thereof

The self-contained observational device can include at least one adhesive strip operable for adhering the self-contained observational device in a position to observe the persons.

The enclosure can have at least one window positioned to permit at least one of the presence sensor, the camera, and the WIFI module to have sight of the persons.

The at least one window can have no covering.

The at least one window can have a transparent covering.

The self-contained observational device can include a label. The label can provide an address to which the self-contained observational device can be sent after use of the system.

The label can include a bar code or a QR code.

The non-wall power source can be a battery pack that includes one or more batteries.

The presence sensor can include an infrared sensor.

The system can be operable to determining using the presence sensor that there are no person located proximate to the device and, upon such determination, the system is operable to control the camera to not take the images.

The mobile device can be a smart phone, mobile computer, or tablet.

The data from the mobile device can include the MAC address of the mobile device.

The observational device can include at least one trigger.

The observational device can include at least one input. The input can be selected from the group consisting of lights, sounds, and servo motors.

The observational device can include another sensor. The another sensor can be selected from the group consisting of infra-red devices, sonar distance sensors, microphones, photocells, inductive/capacitive proximity sensors.

The observational device can further include a display. The display can be operable to gather additional information from the persons.

The system can include a communication module operable to transmit the information gathered by the observational device.

The WIFI module can be the communication module.

The communication module can be selected from the group consisting of radio modules, bluetooth devices, and zigbee devices.

The system can further include a monitoring and analyzing system. The monitoring and analyzing system can be operably in communication with the observational device.

The monitoring and analyzing system can be connected to a wall-power source.

The can include a communication module operable to transmit the information gathered by the observational device to the monitoring and analyzing system.

The communication module can be operable to transmit the information in real time.

The WIFI module can be the communication module.

The communication module can be selected from the group consisting of radio modules, bluetooth devices, and zigbee devices.

The monitoring and analyzing system can be operable to analyze the information gathered from at least the observational device and make determinations of the persons.

The determinations of the persons can be selected from the group consisting of interests likes and dislikes of the persons, personality traits of the persons, product feedback, and combinations thereof

The monitoring and analyzing system can be operable to transmit the determinations to the communications module in real time.

The WIFI module can be the communication module.

The communication module can be selected from the group consisting of radio modules, bluetooth devices, and zigbee devices.

The observational device can further include an output. The output can be operable to provide to the content to the persons in response to the determinations.

In general, in another embodiment, the invention features a method. The method includes selecting an observational device. The observational device includes a presence sensor, a camera, a WIFI module, a processor, and a non-wall power source. The processor is electrically connected to the presence sensor, the camera, and the WIFI module. The non-wall power sources power for the presence sensor, the camera, the WIFI module, and the processor. The method further includes positioning the observational device at a first location proximate traffic of persons. The observational device is not connected to a wall-power-source. The method further includes utilizing the presence sensor over a pre-set period to sense the traffic of the persons. The method further includes utilizing the camera over the pre-set period to intermittently take images of the persons. The method further includes utilizing the WIFI module over the pre-set period to obtain data from mobile devices carried by the persons. The method further includes utilizing the processor over the pre-set period to save information gathered by the presence sensor, the camera, and the WIFI module. The method further includes transferring the information away from the first location.

Implementations of the invention can include one or more of the following features:

The step of transferring the information away from the first location can include transferring the information to a monitoring and analyzing system located at a second location. The method can further include utilizing the monitoring and analyzing system to generate determinations about the persons based upon the information.

The pre-set period can be at least 60 days.

The observational device can be a self-contained observational device.

The self-contained observational device can include an enclosure made of a light, durable material.

The self-contained observational device can include at least one adhesive strip. The step of positioning the observational device can include comprises using the adhesive strips to adhere the self-contained observational device in a position to observe the persons.

The enclosure can have at least one window. The step of positioning the observational device can position the window to permit at least one of the presence sensor, the camera, and the WIFI module to have sight of the persons.

The observational device can include a bar code or a QR code.

The method can further include a step of scanning in the bar code or the QR code to indicate the positioning of the observational device at the first location.

The observational device can be operably connected to a display. The display can be operable to gather additional information from the persons.

The step of transferring the information can occur after the pre-set period.

The step of transferring the information can include removing the observational device from the first location. The step of transferring the information can further include sending the observational device to a second location at which the monitoring and analyzing system is located.

The step of sending the operational device can include mailing the observational device.

The observational device can include a bar code or a QR code. The method can further include the step of scanning in the bar code or the QR code to indicate the positioning of the observational device at the first location. The method can further include utilizing the monitoring and analyzing system to generate determinations about the persons based upon the information and based upon the bar code or the QR code scanned data.

The step of transferring the information can include intermittently downloading the information from the observational device.

The downloading can be performed using a wired connection to the observational device.

The step of transferring the information can include comprises wirelessly sending the information to a monitoring and analyzing system located at a second location.

The wireless sending the information can include sending the information via a transmission medium selected from the group consisting of WIFI, a radio transmission, a cellular network, bluetooth, and zigbee.

The step of transformation can be sent to the monitoring and analyzing system in real time.

The determinations about the persons can be generated in real time.

The method can further include utilizing the determinations in real time to provide content to the persons in response to the determinations.

### BRIEF DESCRIPTION OF THE DRAWINGS

FIG. 1 illustrates a front perspective view of an embodiment of an observation device of the present invention.

FIG. 2 illustrates a back perspective view of the embodiment shown in FIG. 1.

FIG. 3 illustrates the front perspective view of the embodiment shown in FIG. 1, with the outer walls of the device transparent.

FIG. 4 illustrates the card (includes the power circuit board with its various electronic components) shown in FIG. 3 of the embodiment shown in FIG. 1.

FIGS. 5A-5B illustrate the embodiment of FIG. 1 with alternative coverings on the front side of the embodiment. Such coverings can be used before and after the use of such embodiment, particular when the embodiment is being sent to or from the retail store.

FIG. 6 illustrates a display having the embodiment of FIG. 1 installed for use.

FIG. 7 illustrates a magnified view of a portion of the display shown in FIG. 6.

FIG. 8 illustrates a side view shown along line A-A′ of FIG. 7.

FIG. 9 illustrates an alternative display having the embodiment of FIG. 1 installed for use.

FIG. 10 illustrates an embodiment of an observational system of the present invention.

FIG. 11 illustrates an embodiment of system that includes the observational system of FIG. 10 and a monitoring and analyzing system.

### DETAILED DESCRIPTION

The present invention is directed to an observational device/system, and method of use thereof. The observational device/system is capable of observing customer interactions with a display without the need to be connected to an outlet power source. In some embodiments, the observational device/system is self-contained. The present invention is further system that includes the observational device/system (without the need to be connected to an outlet power source) in communication with a monitoring and analyzing system directly connected to a wall-power source in which the observational device/system is utilized as a scout for gathering information for real-time analysis.

Such observational devices/systems can operate on “non-wall” power. For the purposes of this application, “non-wall power” refers to any power source that is not a physical connection to wall power (so that the observational device/system has the freedom to be moved without the need of physically re-connecting it to a wall-power source).

### Observation Device/System

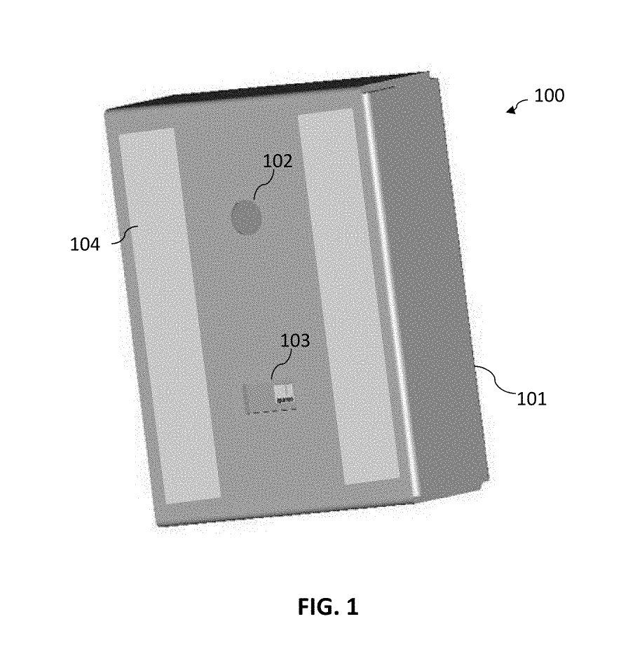

Referring to FIG. 1, this illustrates a front perspective view of observation device 100. The observation device 100 is generally around the size of a pack of cards or smaller. The enclosure 101 can be box shaped and made of a lightweight, but durable material, such as cardboard or plastic. Adhesive strips 104 are attached to the enclosure 101 for readily securing the observation device 100 to a display. While the adhesive strips 104 are shown on the front side of observation device 100, alternative embodiments can position the adhesive strips 104 in any orientation needed for proper securing. Adhesive can be semi-permanent, or a hook-n-loop fastener material (such as a Velcro material), to enable the device to be removed and replaced easily.

The enclosure 101 has one or more windows to provide “sight” by certain electronic components of the device. As shown in FIG. 1, enclosure 101 has two windows (windows 102 and 103). In sure, the windows are typically open with no covering, although a transparent material (such as glass or clear plastic) can be utilized.

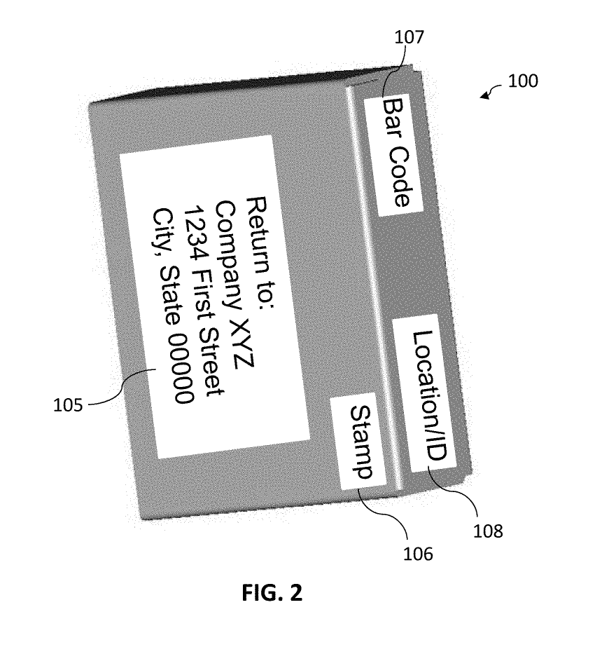

FIG. 2 illustrates a back perspective view of the observation device 100. As the observation device 100 is a self-contained package, in the embodiment of the observation device 100 shown, it has mailing address 105 and a stamp 106 so that the user can readily send observation device 100 back in after use so that the information gathered by the observation device 100 can be analyzed. To further assist, the observation device has a bar code 107 (or QR code or the like) that identifies the device and can also include a location/ID strip 108 in which the actual location of the retail store and/or particular display can be further recorded to tie the observation device 100 to what it is observing. In some embodiments, such location/ID strip will be identifiers hand-written at the retail store location. For example, if a QR code is utilized, a serial number can be embedded inside of the QR code, so when it is scanned by an installer's smart phone, the device registers on a network—utilizing the GPS location of the installer's smart phone.

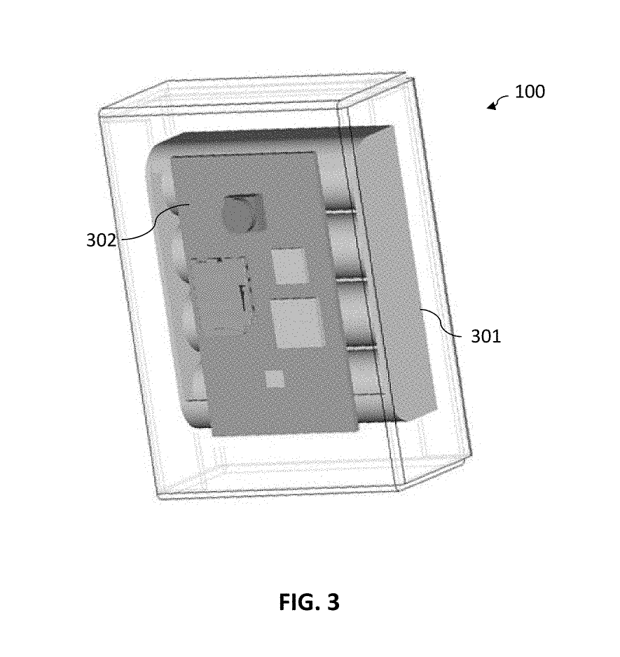

FIG. 3 illustrates the front perspective view of observation device 100 with enclosure 101 shown as transparent walls. The observation device 100 has a battery pack 301, which can contain batteries, such as standard AA or AAA batteries. Typically, these will contain sufficient charge to maintain operation of the observation device for a 60-90 day period of time.

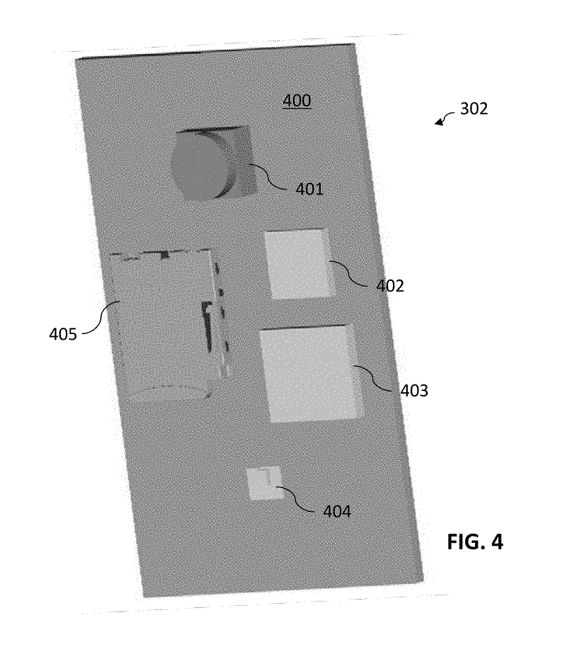

The observation device 100 also includes the card 302 for the device. The card 302 is shown in more detail in FIG. 4. The card 302 includes a printed circuit board 400 with various electronic components.

The components of the card 302 include a presence sensor 404 that can sense customer traffic (customer count, direction of the traffic, dwell time of the customers, velocity of the customer, etc.). In some embodiments, the presence sensor 404 is an infrared sensor model no. AK9750 from Ashahi Kasei Microdevices (Tokyo, Japan), which is a one-chip ultracompact passive infrared sensor integrated circuit that is suitable for human detection sensing. Other similar types of sensors can also be used, such as time-of-flight, luminance, or passive infra-red sensors.

The components of the card 302 further include a camera 401 that can intermittently take still images of customers interacting with the display. In some embodiments, the camera 401 can be the same type of camera used in security cameras of Blink, NetGear Arlo, and Homeboy. The rate of such intermittent imaging of camera 401 generally will depend on the customer traffic. For instance, when no customer traffic is detected or traffic is determined to be quickly moving by the display, there is no need for imaging to be taken by the camera 401. Such inactivity will conserve power from the batteries in the battery pack 301 and reduce the amount of data that need be stored by the device. However traffic data can still be recorded. Further, for instance, as different customers are perceived, the rate of imaging by the camera 401 can be increased.

The components of the card 302 further include a WIFI module 403, such as a WIFI networking module model no. AMW007 (Spectre) from Zentri (Los Gatos, Calif.). Typically, a customer will carry with himself/herself a smart phone or other mobile device. Smart phones and other mobile devices today have WIFI and Bluetooth built into them. By the standard of WIFI, devices such as smart phones, mobile computers, and tablets, are continuously device looking for networks to communicate with. To accomplish this, these devices are continuously broadcasting a header which contains that particular devices Media Access Control (MAC) address. A MAC address is a networking identifier address that is unique to that particular device. There will be no other device in the world that would share a MAC address. Additionally, Bluetooth devices also have unique MAC addresses that are also broadcast when Bluetooth is enabled and the device is looking for other devices to connect, or pair, with. The WIFI module 403 will capture data regarding the MAC address. The WIFI module 403 will also be able to record the signal strength, which will further be information that can be used for analyzing purposes.

The WIFI module can also include an embedded Bluetooth or Bluetooth Low Energy, or other radio that enables the device to also work as a beacon sensor. As an alternative to the WIFI module, module 403 can be any wireless or radio communication module, such as a radio module, a Bluetooth device, or a Zigbee device, that can obtain data from mobile devices carried by persons.

The components of the card 302 further include a processor 402, such as microcontroller/microprocessor model no. RZ/A1 of Renesas Electronics America (Santa Clara, Calif.). The components of the card 302 also include a memory or storage card 405 that will save all of the information collected by the observation device 100 (i.e. from the presence sensor 404, the presence camera 401, and the WIFI module 403).

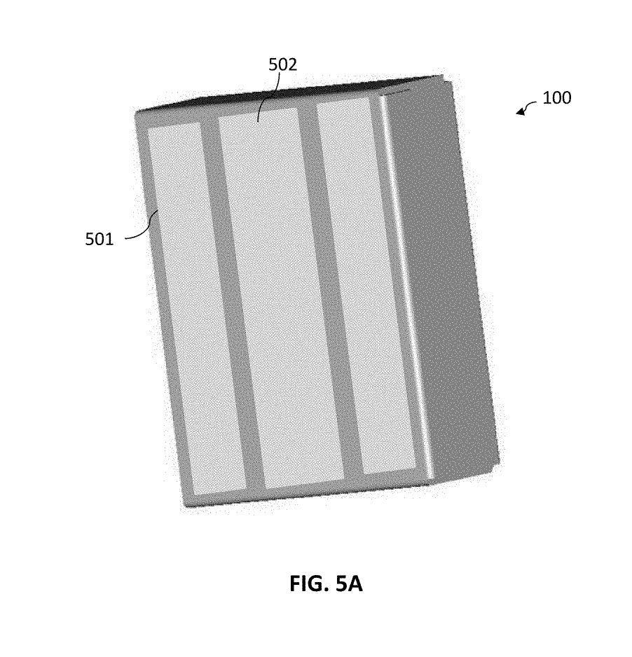

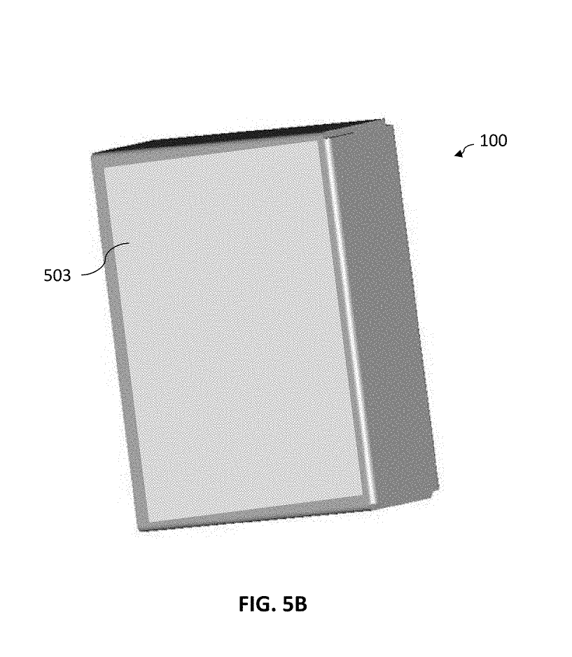

FIGS. 5A-5B illustrate observation device 100 with alternative coverings on the front side of the embodiment. Such coverings can be used before and after the use of such embodiment, particular when the embodiment is being sent to or from the retail store for use. As shown in FIG. 5A, removable liners 501 are positioned on top of each of adhesive strips 104. These removable liners can be peeled off separately to expose each of the adhesive strips when it is desired to adhere the observation device 100 to a display. Removable liner 502 is positioned above the windows of enclosure 101 (such as windows 102 and 103). This too can be removed when the observation device 100 is to be put to use. This removable liner 502 covers the windows, which typically are uncovered holes in enclosure 101. This is particularly useful during transfer of the observation device 100 so that the interior elements of the observation device are further protected from exposure.

FIG. 5B illustrates a removable liner 503, which is one piece that covers adhesive strips 104 and the windows of the enclosure 101 (such as windows 102 and 103). If this single removable liner 503 is used before utilization of the observation device 100 at the retail store, the adhesive strips 104 and the windows of the enclosure 101 are all uncovered in one step. Moreover, a second removable liner 503 can be provided with an adhesive side (which can be exposed by peeling off a substrate) so that the second removal liner 503 can be applied after use of observation device 100 to protect when sent away from the retail store.

This removable liner can also have some control over the operations of the observation device, in that it can be set to be dormant should the window be covered. Alternatively, the observation device can have a button or other switch (not shown) that can be depressed/moved to turn the observation device on or off

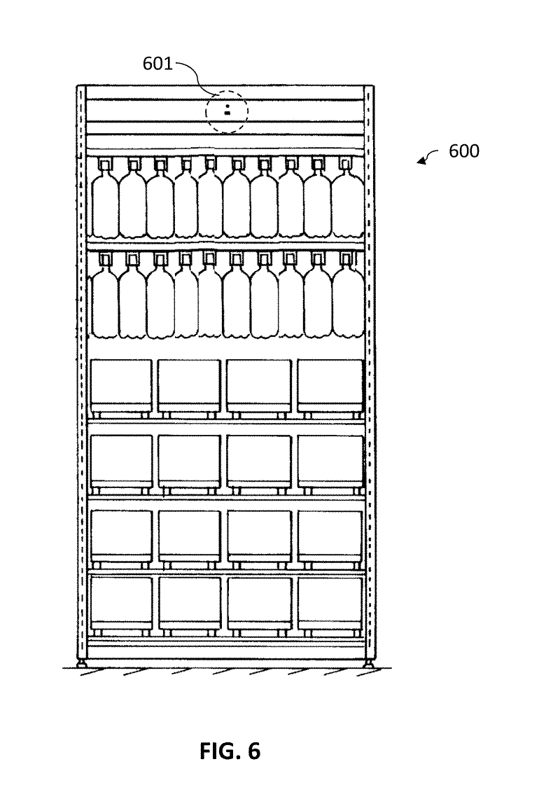

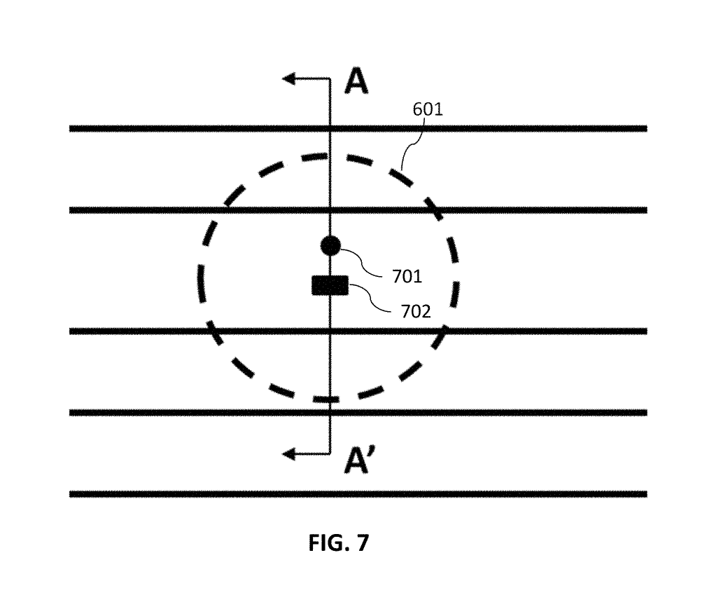

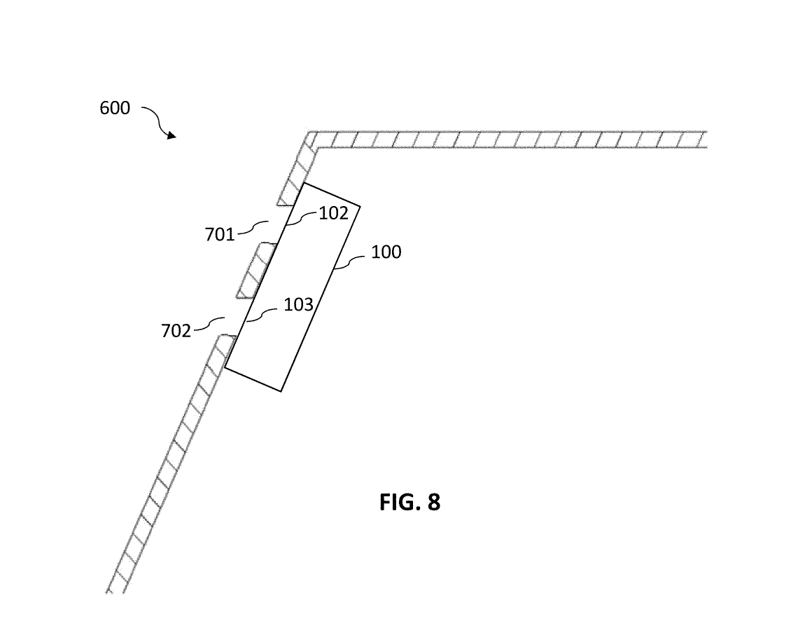

FIG. 6 illustrates a display 600 that has an observation device 100 installed for use. Dotted circle area 601 reflects windows in the display 600 behind which the observation device 100 is installed. FIG. 7 illustrates a magnified view of a portion of the display 600 focusing upon dotted circle area 601. Inside the dotted circle area 601 are windows 701 and 702, which coincide with windows 102 and 103 of observation device 100. FIG. 8 illustrates a side view of dotted circle area 601 shown along line A-A′ shown in FIG. 7. FIG. 8 shows how the observation device 100 is positioned on display 600 such that windows 102 and 103 are not covered and have a line of sight to the customers and the customer stream at the retail store.

In alternative embodiments, the observation device 100 can have the adhesive situated on the back side, and the observation device 100 can be positioned on the front side of the display.

### Method of Installation And Use

By this design, the observation devices of the present invention can be easily and inexpensively installed in a display, without any need for connecting to an external power source or for otherwise connecting the observation device either with via a cable or wirelessly. This renders the observation device self-contained and user friendly to use. A user simply needs to make sure the windows of the observation device are positioned with the proper line of sight (including removing any of the removable liners) and then adhering it properly to the display. As noted above, removing the removable liners and exposing the windows can then begin the operation of the observation device. Typically, the installer will write the location ID on the side of the observation device, such on the location strip (which is shown in FIG. 2 as location strip 108). Again, for instance, if a QR code is utilized, a serial number can be embedded inside of the QR code, so when it is scanned by an installer's smart phone, the device registers on a network—utilizing the GPS location of the installer's smart phone.

Once installed, the observation device works independently of any further user input to gather information about the retail store customers that are passing by the display. Such information is gathered using the various presence sensors, camera, and WIFI modules and saved on the memory card.

For example, the observation device can take pictures each time a shopper walks by and then encrypt and store the data on the memory card. The observation device can also sense for WIFI and then log MAC addresses in text files on the memory card.

After a set period or when the promotion of the display is complete, which can be around 60-90 days, the observation device can be readily removed from the display and then sent away from the retail store (to an analysis center) for analysis of the information gathered by the observation device during this time. If desired, at the time of removal of the observation device, the retail store can install a second observation device that will then continue to gather information going forward.

Again, discussed above, when the observation device is removed, a second removable liner can be attached to cover the windows of the observation device, which will cause the observation device to go dormant (and cease gathering information). The observation device can then be simply put in the mail as the observation device already contains the mailing information to mail it back to the analysis center, such as shown in FIG. 2.

When the observation device is received by the analysis center, the information gathered by the observation device can be processed and analyzed. Such information can be analyzed to provide valuable insight on who the shoppers were (demographics, etc.), when and how long the customers visited the point-of-purchase display, and the extent to which the customers engaged with the point-of purchase display. For instance, the images saved by the observation device can be run through facial intelligence software. Further examples of types of analysis that can be performed of this gathered information and how this analysis is useful to the retail store is described in Garel '936 Application.

The analysis center can then create an intelligence report and provide this report back to the retail store. For example, this can be done using a web dashboard that can be accessed by the retail store. In some embodiments, the web dashboard can be made available to the retail store for a period of time, such as 90 days, and then archived for a longer period (such as 24 months).
Such reports can include:
Customer traffic count;
Customer age;
Customer gender;
Customer attentiveness;
Customer frequency of visits; and
Multiple location insights.

For instance, multiple location insights can occur when the retail store provides multiple displays within the same retail store or a group of retail stores (such as retails stores in the same chain) aggregate data.

The embodiments of the present invention have a simple ease of use. Moreover, the cost for the observation device is quite economical. Generally, other than the batteries and the enclosure, the components of the present invention can be reused multiple times. Hence, once the information from the observation device is downloaded for analysis, it can be quickly refabricated with new batteries and a new enclosure, and sent back in the field for use to gather further information at a retail store.

### Additional Observational Devices/Systems

In further embodiments of the present invention, the WIFI module can be used to connect and download the information from the device wireless.

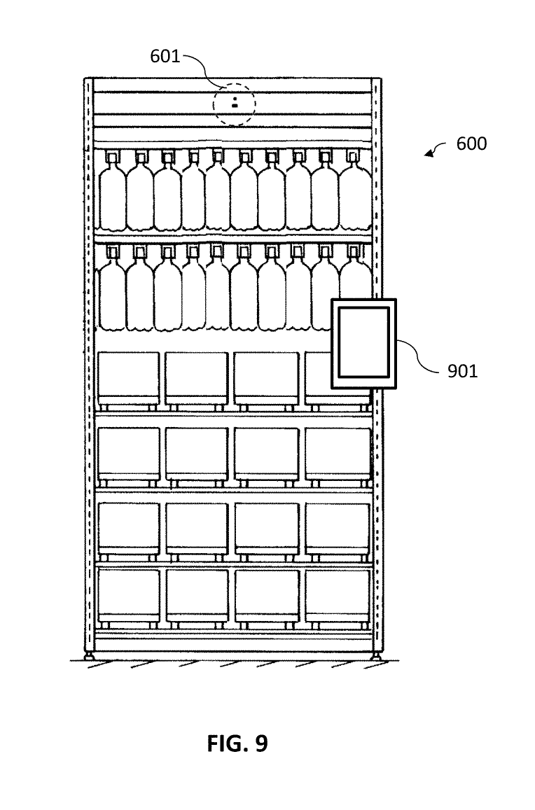

Moreover, an electronically addressable display device, such as an eInk display from eInk (Billerica, Mass.) can be included at the display to engage shoppers with personalized content. Such embodiment is shown in FIG. 9, which is display 600 as described in FIG. 6, with an electronically addressable display device 901. Buttons can be included on the display and these can then be used by the customers to trigger content, with the shopper touches recorded by the observation device.

With the WIFI established, live images and other data can be sent to the cloud for demographic processing to change the electronically addressable display device in real time.

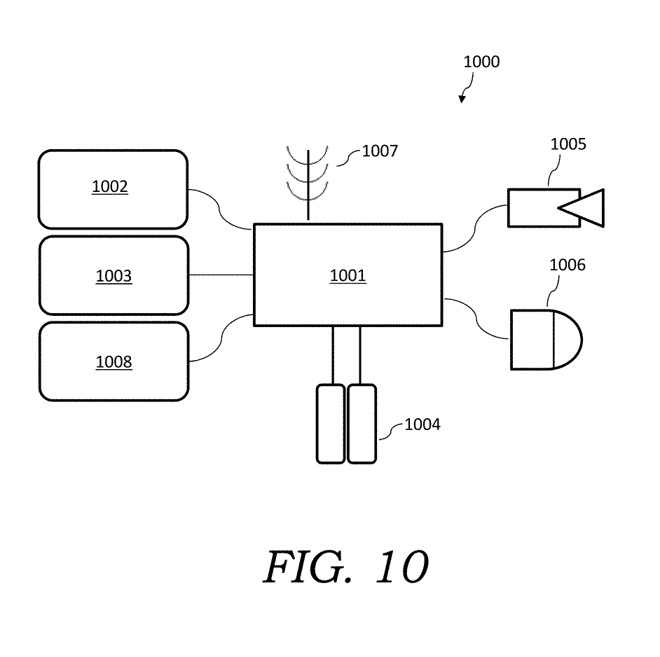

In another embodiment, FIG. 10 illustrates the components of an embodiment of an observational system 1000 of the present invention. Observational system 1000 is a system based on a low-power microcontroller 1001 (which includes or additionally has memory coupled thereto for saving data). Such microcontroller 1001 can be a Texas Instruments CC3200. Observational system 1000 further includes a wireless communication device 1007 (such as a wireless radio, Wi-Fi, Bluetooth, etc.). For instance, the CC3200 microcontroller has built-in Wi-Fi. These allow observational system 1000 to communicate with the cloud or other devices and/or servers within a local network. Observational system 1000 may be powered by batteries (such as a battery pack 1004) or other methods that are not physically connected to wall power, such as power-over-Ethernet.

Observational system 1000 can use various inputs and sensors to maintain low power yet capture valuable shopper behavior data. The types of various inputs and sensors are variable and optional. For instance, the inputs and sensors include triggers 1002, other inputs 1003 (lights, sounds, servo motors, etc.), camera sensors 1005, and other sensors 1006 (infra-red devices, sonar distance sensors, microphones, photocells, inductive/capacitive proximity sensors, etc.).

Observational system 1000 can also have other input and output devices 1008 (such as a display).

To save power, observational system 1000 works by turning on at various times, and being in a sleep mode at others. Such turning on can be by a timed interval (i.e., at a pre-set frequency during normal business hours), upon a trigger from the proximity sensor (such as sensor 1006), such as if a shopper is in front of the device, a trigger 1002 (such as an audio trigger), or a combination thereof

When observational system 1000 is turned on, the device will then power up in access point mode, enabling the wireless communication device 1007 (such as a Wi-Fi radio) to listen for a shopper's Wi-Fi enabled smartphone. Observational system 1000 will store data captured locally in the microprocessor 1001 (with memory). Observational system 1000 will power itself down, such as after another pre-determined time period.

Upon the same or different timed interval (typically a different time interval), observational system 1000 will turn on in “endpoint” mode. Once the observational system 1000 is in endpoint mode, the observational system 1000 will transfer data stored in microprocessor 1001 (with memory) to the cloud or local network device for processing. This method will allow the observational system 1000 to operate in a power efficient mode, yet provide data to a cloud or local network server for processing, analytics, and visualization.

Optionally, the proximity sensor 1006 can capture shopper traffic count and shopper dwell time, and store that information to the onboard memory with microprocessor 1001. When the observational system 1000 turns on in endpoint mode, the system can transfer proximity data to the cloud or local network for processing.

Observational system 1000 can capture audio for analyzing audible information discussed at the shelf. When observational system 1000 identifies a shopper is in front of or nearby the device (through audio sensing, proximity sensor, or some other sensor), the observational system 1000 can begin recording audio. The audio can be transferred to the cloud or local network for analysis and processing. This analysis can be used to determine information, such as shopper interests likes and dislikes, shopper personality, product feedback, and other spoken information.

Observational system 1000 can also include a camera module 1005 for video processing. When observational system 1000 senses a shopper is in front or nearby the device (using audio sensing, proximity sensor or some other sensor), the observational system 1000 can turn on and capture an image in the aisle. Additionally, observational system 1000 may boot in access point mode, and therefore also capture the shopper's Wi-Fi address information. All information captured can be stored on the memory of observational system 1000. Observational system 1000 would then be able to send the image captured by the camera sensor up to the cloud or local network device. The image would be processed to determine information such as age, gender, and emotion.

The observational system 1000 can also use other inputs such as buttons, sound sensors/microphones, and other sensors to accept shopper input—actively and passively. These inputs can be stored on the system's memory and transmitted to the cloud or other network device for processing and aggregation with other data.

By using information such as the presence of a person, loyalty based off Wi-Fi smartphone information, and responses from the cloud or local network device on shopper age, gender, and emotion; the system can use the I/O included in the microcontroller to control external devices 1003 and 1008. Again, these devices could include things such as lights, sounds, servo motors, application programming interfaces (APIs) to external devices, APIs to proximity devices, APIs to video displays, and other features that could deliver a responsive experience to the shopper. These experiences could be based on the presence of a person, or could be targeted and personalized to them based upon the information gathered from the system's onboard sensors (and also received back via the cloud or via local network after processing).

Many commercially available digital signage players have the ability to use external triggers to display content on the digital sign. Using information gathered from the sensors about the shopper, the system can trigger events for digital signage players. This would enable standard digital signage players to deliver targeted and personalized digital content to shoppers in store. An example of a digital signage is BrightSign players (BrightSign, LLC, Los Gatos, Calif.).

Observational system 1000 can be turned into a smart Bluetooth beacon (using wireless communication device 1007). This allows observational system 1000 to engage and interact with a shopper's mobile phone through an application that the shopper has downloaded. Using information gathered from the system's sensors 1005 and 1006, the mobile application would be able to provide a more targeted and personalized experience.

In some embodiments, the observational system 1000 will work with the Wi-Fi Aware standard (which is a capability of Wi-Fi which enables power-efficient discovery of nearby information and services before making a connection). See http://www.wi-fi.org/discover-wi-fi/wi-fi-aware#sthash.kLlbaJw3.dpuf. Wi-Fi Aware allows observational system 1000 to send a message to a shopper's mobile phone through Wi-Fi. Because observational system 1000 is connected to the cloud through a Wi-Fi connection, observational system 1000 can be regularly updated so that the Wi-Fi Aware message is up to date—and allows the retailer and brand to regularly change the message. Additionally, because observational system 1000 uses sensors to gather information about that shopper, the Wi-Fi Aware message can be personalized to the individual shopper.

### Systems Including Observational Devices/Systems and Monitoring and Analyzing Systems

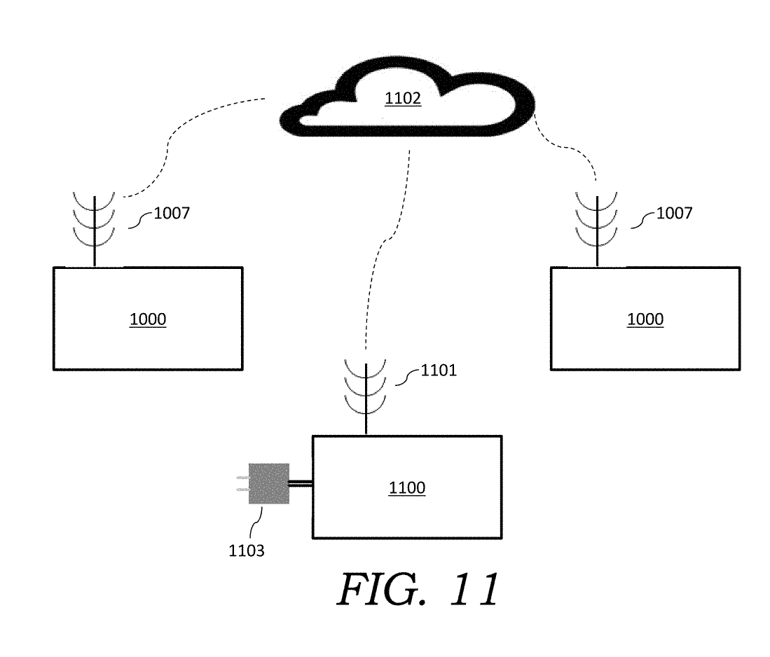

FIG. 11 illustrates an embodiment of the present invention, in which one or more observational system 1000 are located throughout the retail store. These are communicatively coupled (via cloud 1102 or, alternatively, via a local network (not shown)) with monitoring and analyzing system 1100 (having wireless communication device 1101). The monitoring and analyzing system 1100 can be powered by a wall-power source (i.e., physically connected to a wall-power source via a plug 1103 or via other connector to wall-power source). Providing a wall-power source to the monitoring and analyzing system 1100 allows monitoring and analyzing system 1100 to have sufficient and long term power to perform the processing and analytics of consumer purchasing behavior in real-time. Such monitoring and analyzing system 1100 (and its aspects and abilities) are disclosed and taught in the Garel '936 Application.

Hence, in many ways, observational systems 1000 are “scout” systems that allow information regarding the shoppers to be obtained at various points in the retail store, in which these scout systems do not need to be connected to wall-power sources. These observational systems 1000 can then relay the information to monitoring and analyzing system 1100 (via wireless communication devices 1007 and 1101) for real time evaluation. Optionally, the observational systems 1000 can then use such analytics (received from monitoring and analyzing system 1100) in real time to further relay information (such as via a display) to enhance the shopper's experience. For instance, observational systems 1000 can provide further detail to the shopper about the brand (including information most likely to be of interest to that individual based on the demographic information about the shopper derived from system 1000).

By way of example, an observational system 1000 can be placed at the front of a store in a display that is seen by the shopper upon entering the retail store. Since this is far from the shelf (holding the displayed product and other related products), it may be difficult/impossible to have a nearby wall—power source to this display. The observational system 1000 remains in sleep mode unless triggered by the presence of a shopper (or due to a time frequency). The observational system 1000 can obtain audible and visual information about the shopper. The observational system 1000 can then relay the information to monitoring and analyzing system 1100 (which can be, for example, at the shelf space within the retail store where there is a wall-power source). The monitoring and analyzing system 1100 can then perform various analytics and other processing. For instance, monitoring and analyzing system 1100 can use a visual image taken with the camera sensor 1005 of observational system 1000 for the purpose of determining demographical and behavioral characteristics of the shopper to improve services and relevancy of product information delivered to the shopper. These improved services and more relevant information can then be displayed both at the shelf (where monitoring and analyzing system 1100 is located) and at any of the observational systems 1000 located throughout the retail store. Indeed, observational systems 1000 can be used to direct the shopper to the shelf for further information, to acquire the product, and to receive and ancillary goods and services.

Furthermore, if the retail store determines that the display needs to be moved, this can be readily done without concern for a nearby wall-power source. Hence, the displays are readily re-locatable.

By this process, a battery pack 1004 in can have a lifetime of several months (or longer) before needing replacement or recharging. Since observational system 1000 is in communication via the cloud or via a local network, the observational system 1000 can indicate when the power in battery pack 1004 is running low, enabling proactive replacement or recharging and ensuring continuous service.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

It is also to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

What is claimed is:

1. A system comprising an observational device, wherein the observational device comprises:
(a) a presence sensor, wherein the presence sensor is operable to sense traffic of persons in proximity of the observational device;
(b) a camera, wherein the camera is operable to intermittently take images of the persons;
(c) a WIFI module, wherein the WIFI module is operable to obtain data from mobile devices carried by the persons;
(d) a processor, wherein
(i) the processor is electrically connected to the presence sensor, the camera, and the WIFI module and
(ii) the processor is operable to save information gathered by the presence sensor, the camera, and the WIFI module; and
(e) a non-wall power source, wherein
(i) the non-wall power sources power for the presence sensor, the camera, the WIFI module, and the processor, and
(ii) the observational device operable for use for a pre-set period of time without being connected to a wall-power source.

2. The system of claim 1, wherein the pre-set period of time is at least 60 days.

3. The system of claim 1, wherein the system is the observational device.

4. The system of claim 3, wherein the observational device is a self-contained observational device.

5. The system of claim 4, wherein the self-contained observational device comprises an enclosure made of a light, durable material.

6. The system of claim 5, wherein the self-contained observational device comprises at least one adhesive strip operable for adhering the self-contained observational device in a position to observe the persons.

7. The system of claim 5, wherein the self-contained observational device comprises a label, wherein the label provides an address to which the self-contained observational device can be sent after use of the system.

8. The system of claim 7, wherein the label comprises a bar code or a QR code.

9. The system of claim 1, wherein
(a) the system further comprises a monitoring and analyzing system, and
(b) the monitoring and analyzing system is operably in communication with the observational device.

10. The system of claim 9, wherein
(a) the system comprises a communication module operable to transmit the information gathered by the observational device to the monitoring and analyzing system; and
(b) the monitoring and analyzing system is operable to analyze the information gathered from at least the observational device and make determinations of the persons.

11. A method comprising:
(a) selecting an observational device, wherein the observational device comprises
(i) a presence sensor,
(ii) a camera,
(iii) a WIFI module,
(iv) a processor, wherein the processor is electrically connected to the presence sensor, the camera, and the WIFI module, and
(v) a non-wall power source, wherein the non-wall power sources power for the presence sensor, the camera, the WIFI module, and the processor;
(b) positioning the observational device at a first location proximate traffic of persons, wherein the observational device is not connected to a wall-power-source;
(c) utilizing the presence sensor over a pre-set period to sense the traffic of the persons;
(d) utilizing the camera over the pre-set period to intermittently take images of the persons;
(e) utilizing the WIFI module over the pre-set period to obtain data from mobile devices carried by the persons;
(f) utilizing the processor over the pre-set period to save information gathered by the presence sensor, the camera, and the WIFI module; and
(g) transferring the information away from the first location.

12. The method of claim 11, wherein
(a) the step of transferring the information away from the first location comprises transferring the information to a monitoring and analyzing system located at a second location; and
(b) the method further comprises utilizing the monitoring and analyzing system to generate determinations about the persons based upon the information.

13. The method of claim 11, wherein the pre-set period is at least 60 days.

14. The method of claim 11, wherein the observational device is a self-contained observational device.

15. The method of claim 11, wherein the self-contained observational device comprises an enclosure made of a light, durable material.

16. The method of claim 15, wherein
(a) the self-contained observational device comprises at least one adhesive strip, and
(b) the step of positioning the observational device comprises using the adhesive strips to adhere the self-contained observational device in a position to observe the persons.

17. The method of claim 15, wherein the observational device comprises a bar code or a QR code.

18. The method of claim 11, wherein
(a) the step of transferring the information occurs after the pre-set period;
(b) the step of transferring the information comprises
(i) removing the observational device from the first location, and
(ii) sending the observational device to a second location at which the monitoring and analyzing system is located; and
(c) the step of sending the operational device comprises mailing the observational device.

19. The method of claim 18, wherein
(a) the observational device comprises a bar code or a QR code;
(b) the method further comprises the step of scanning in the bar code or the QR code to indicate the positioning of the observational device at the first location; and
(c) the method further comprises utilizing the monitoring and analyzing system to generate determinations about the persons based upon the information and based upon the bar code or the QR code scanned data.

20. The method of claim 11, wherein the step of transferring the information comprises wirelessly sending the information to a monitoring and analyzing system located at a second location.
